(19) United States
(12) Patent Application Publication
(10) Pub. No.: US 2008/0281918 A1
(43) Pub. Date: Nov. 13, 2008

(54) SYSTEM AND METHOD FOR SHARING INFORMATION IN NETWORKS

(76) Inventor: Michael Kirkwood, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/868,937

(22) Filed: Oct. 8, 2007

Related U.S. Application Data
(60) Provisional application No. 60/917,618, filed on May 11, 2007.

(51) Int. Cl. G06F 17/30; G06F 15/16; H04L 12/56

(52) U.S. Cl. 709/205; 370/352; 707/103 R

(57) ABSTRACT

System and method for sharing information in a network is provided. The system creates and maintains relationships between data elements in a network using a first server configured to store a unique identity object for a first data element. The server distributes the unique identity object to other servers. A plurality of contexts are associated with the first data element and applied to the element. Utilizing the applied context, relationships are created with other data elements in the network.

### CROSS-REFERENCE TO RELATED APPLICATIONS

This application claims the benefit of co-pending U.S. Provisional Application No. 60/917,618 filed on May 11, 2007, the disclosure of which is incorporated by reference herein in its entirety.

### BACKGROUND OF THE INVENTION

1. Field of the Invention

This application relates to the management of entities, identities, and contexts in a network, such as a computer network, voice network, or some other link between objects through a defined protocol. More particularly, this application relates to a system and method for modeling and abstracting information representing real world objects and ideas to enable more persistent, secure, and easy to use applications for people and businesses.

2. Description of the Related Art

In recent years, society has become more and more reliant upon the electronic exchange of information in order to provide insight into real world scenarios and conditions. Businesses in particular, rely on the capture, storage, and analysis of data and information to improve efficiency and accuracy in their business models. As an increasing number of businesses have begun storing important information, a need arose for companies to share information and data with each other in order to improve how they conduct business with each other.

For example, when two companies conducted a business transaction, each of their respective data systems needed to be updated to reflect that transaction. However, there was a problem in that companies tended to use non-standardized systems which prevented them from easily sharing information. To address this problem, standards for structuring information to be electronically exchanged were proposed. One of the better known standards developed to address these needs is Electronic Data Interchange (EDI) which is a set of specifications which allows trading partners to exchange information with little regard to the type of software or system installed on the other side of the transaction.

EDI and other technologies have improved the sharing of electronic information. However, there remains a considerable amount of information and data which is not captured through the existing EDI technologies. For example, although business transactions may be captured in significant detail, the computer systems which support these transactions do not enable effective data information flow across the entire supply chain, especially between dimensions such as time or connection points. Although the computer systems of manufacturers are typically configured to effectively share information with their distributors, as products proceed further along the supply chain to retailers and ultimately to consumers, the corresponding transaction data is not effectively communicated back up the chain. One consequence of this disconnect is that information about consumers is not effectively distributed to others in the supply chain.

Take, for example, the case of when a person moves to a new home. Many companies in the supply chain may store information about the person. However, when the person moves to the new home, this information is not made available to the companies unless the person takes affirmative steps to update their information with each company. Moreover, even if the person takes steps to update their information with one company in the supply chain, the companies do not effectively share this information with other companies with whom they conduct business. In sum, there is no identity synchronization between many disparate computer systems and networks within the supply chain. Although some attempts have been made to provide this type of service, such as Microsoft Passport, these services are generally limited to the consumer/retailer side of the supply chain, and do not adequately address the needs of manufacturers and distributors, nor the needs of the individual, who is an critical source of the information about themselves. Accordingly, what is needed is a system which solves these and other shortcomings.

### SUMMARY OF THE CERTAIN INVENTIVE ASPECTS

The system, method, and devices of the present invention each have several aspects, no single one of which is solely responsible for its desirable attributes. Without limiting the scope of this invention, several of its features will now be discussed briefly.

In a first embodiment, a system for creating and maintaining relationships between data elements in a network comprises a server configured to store a unique identity object for a first data element and distribute it to other servers. The system further includes a first module configured to store a plurality of contexts associated with the first data element and a second module configured to apply one of the stored contexts to the first data element. A third module is configured to provide a relationship between the first data element and other data elements using the applied context.

In another embodiment, a system for creating and maintaining relationships between persons and other entities comprises a server configured to store a unique identity object for each person. The system also includes a first module is configured to store a plurality of contexts associated with each person and a second module configured to apply one of said contexts to a first person. A third module is configured to provide a relationship between said first person and the other entities using the applied context.

In yet another embodiment, a computer-implemented method of transmitting data between a first entity and other entities based on predefined relationships between the entities, the entities being connected to a digital network is provided. The method includes receiving a message indicative of the first entity's presence in a location; selecting a context for the first entity based at least in part on the location; determining the first entity's relationships with other entities which are relevant to the entity in the selected context; and sending context-sensitive data from at least one of the other entities to the entity based on the entity's relationships.

### BRIEF DESCRIPTION OF THE DRAWINGS

In this description, reference is made to the drawings wherein like parts are designated with like numerals throughout.

FIG. 1 is a block diagram that provides a top-level overview of how a person connects to a network in accordance with various embodiments.

FIG. 2 is a block diagram of an entity data object of the network from FIG. 1.

FIG. 3 is a block diagram of an identity data object of the network from FIG. 1.

FIG. 4 is a block diagram showing examples of context in which entities and identities may exist.

FIG. 5 is a block diagram illustrating how an identity may be represented within the network based on the contexts from FIG. 4.

FIG. 6 is an example of how two real world persons may share information based on the context.

FIG. 7 is a block diagram providing an example of the use of context to manufacturer coupon information across a supply chain.

FIG. 8 is a flowchart of a process by which the network of FIG. 1 sets a context for a device connecting to the network.

FIG. 9 is a flowchart of a process for sending a coupon to a mobile device of a user based on a defined context.

FIG. 10 is a flowchart of how the network may handle a transaction from FIG. 9.

FIG. 11 is a flowchart of how the network may handle a user's change of address request.

### DETAILED DESCRIPTION

Various embodiments include systems and methods which provide persons and businesses with the ability to share information across the supply chain in a way that allows real world entities to be abstracted as data objects, and allows access to the data objects based on their ever-changing context in the world around them. By connecting data objects and sharing information among them based on their context, network entities are given more precise control over how information is shared and with whom it is shared.

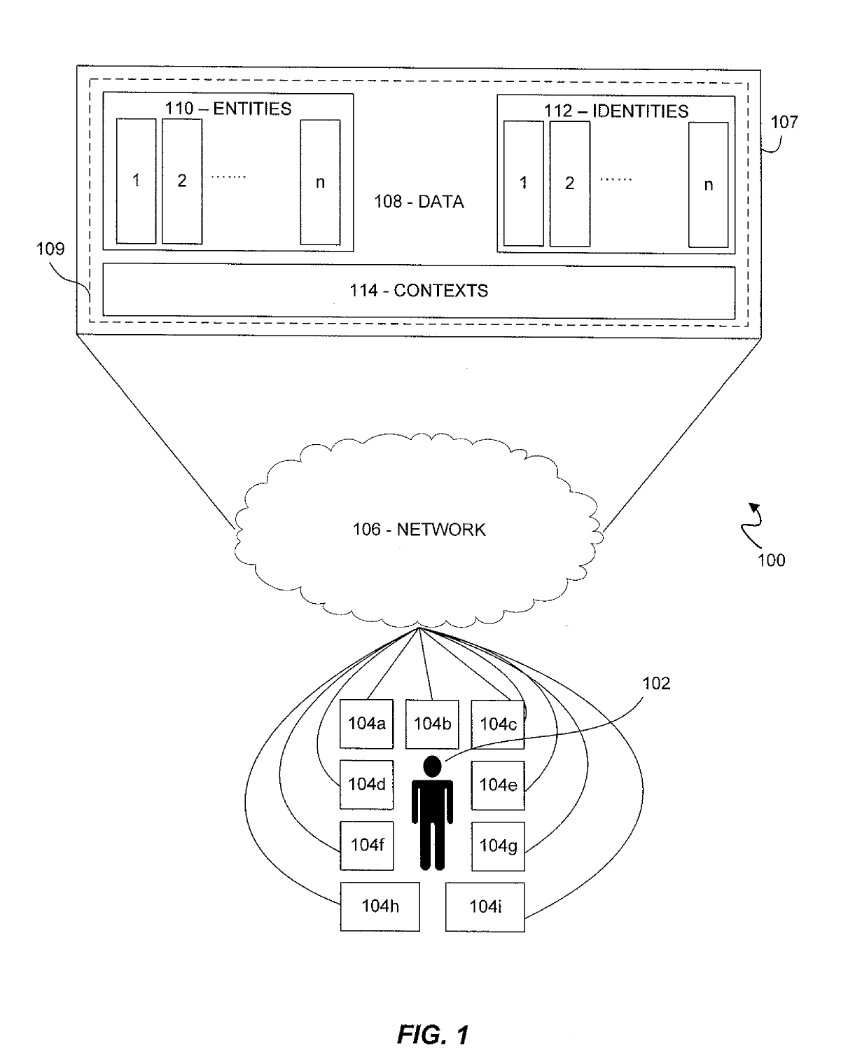

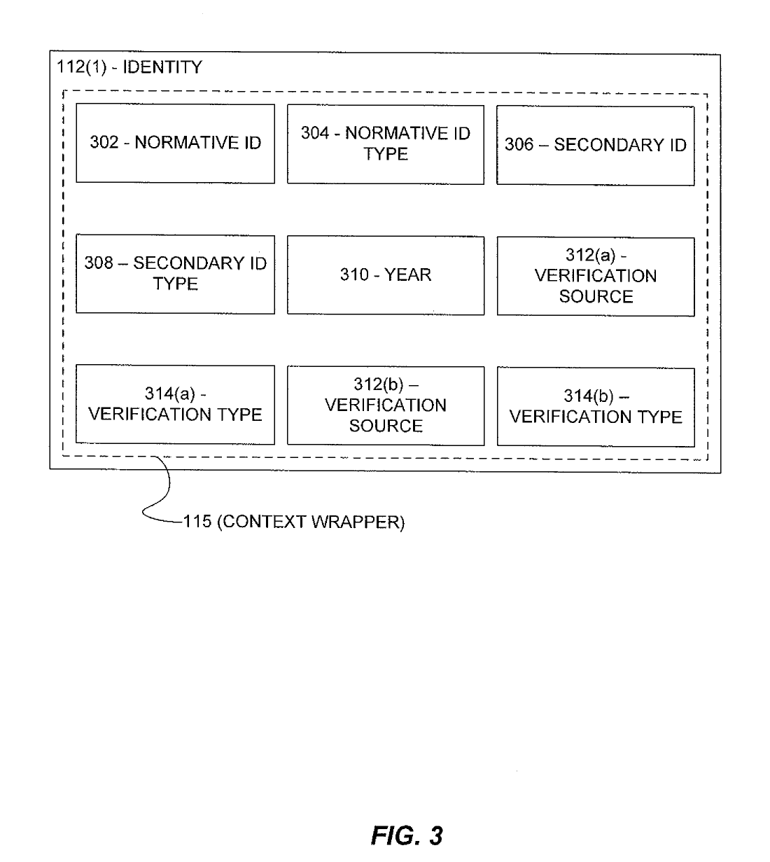

Certain embodiments are implemented within a network environment. FIG. 1 provides a top-level view of a network environment 100 suitable for implementing various embodiments described herein. The network environment 100 includes a network 106. The network 106 is a computer network which may be connected to, or include, various other computer networks such as the Internet, wireless networks such as 3G or WiMAX networks, telephone networks, EDI networks, websites, services, and other types of networks. Connected to the network 106 is a server 107 which includes data 108. At least some of the data 108 is stored as data objects 109 within the server 107. Some of the data objects 109 represent a data abstraction of some real world thing or idea and are termed “identity objects”. The identity objects 112 may represent individual people or individual products. It should be realized that such a data abstraction of a real world person or product is unique to that person or product. Thus, in one embodiment, the identity object for a particular person is unique to that person. There are no other identity objects which represent that particular person. Similarly, a data abstraction of a particular television set is unique to an individual set. There would be one identity object for each separate television set, even if the televisions are identical. For example, each identity object may correspond to a serial number and model number of a particular television set. The identity object 112 is a data object which abstracts an identity, and will be discussed in further detail in connection with FIG. 3.

Other types of objects 109 stored in the server 107 include entity objects 110. As used herein, an entity object is a data object that, in one embodiment, represents an idea of a thing, person, place or product. An entity object 110 is a data object which abstracts a representation of an idea. For example, there may be an entity object which corresponds to 42″ LCD televisions. This object is not specific for an individual television set, but rather represents the concept of a 42″ LCD television. Similarly, there may be entity objects that represent a FORD TAURUS® automobile. The object is not particular to a specific car, but rather represents the type of that car (which may be represented in many different ways in the networks, including different naming convention, within different network protocols).

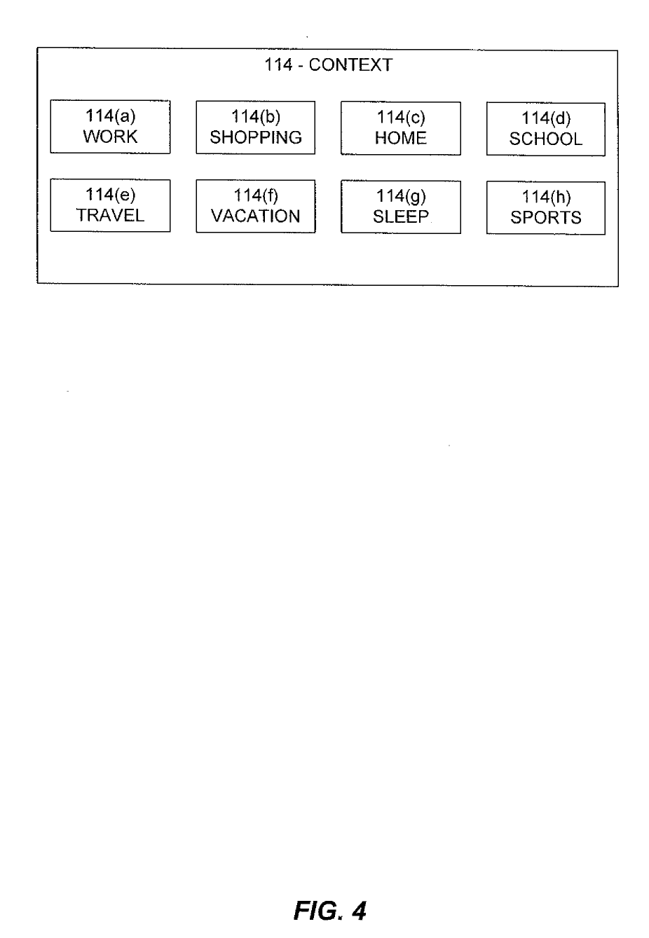

The data objects 109 in the network 106 may further include context data 114. In some embodiments, context refers to the facts or circumstances within which a data object 109 is perceived. In other embodiments, context may include only circumstances within which a data object 109 is perceived, with facts related to a data object stored separately. Context data 114 generally includes data that how other data objects 109 are viewed and referred to within the network 106. For example, a context may be “shopping”, “driving”, or “at work”. Such contexts can be selected by users of the system to indicate how they are currently utilizing data objects. Facts regarding a data object, such as a person named Mike, may include “Mike is a male born in 1977”, “Mike was born at Scripps Memorial Hospital”, “Mike has two children”, or “Mike drives a BMW”. Circumstances regarding Mike may include “Mike is at work”, “Mike is on vacation”, “Mike is shopping for a new car”, or “Mike is sleeping”. Facts regarding a data object, such as a television set, may include “The TV has a 42-inch LCD screen”, “The TV is a flat-screen television”, or “The TV was manufactured by Toshiba”. Circumstances regarding the television set may include “The TV is on”, “The TV is set to channel 13”, or “The TV is broken”. Thus, in some embodiments, circumstances occur over a shorten time span than facts. Circumstances may last an hour, a few hours, a day, a few days, a month, a few months, a year, etc. Facts may be unchanging or occur over longer time spans. A data object may be associated with facts or circumstances that are not currently true, but may be true at times. For instance, The data object corresponding to a person named Mike may include the context “Mike is at work” when Mike is not at work, however the context would not be applied in that case, i.e. the context would not be selected. As, in some cases, the distinction between facts and circumstances can be somewhat arbitrary, in some embodiments of the system, context is broken into a plurality of categories, each category containing a plurality of contexts specific to an estimated time-interval over which it may occur. For instance, “Mike is a male born in 1977″ may be put into a permanent category, “Mike drives a BMW” may be put into a semi-permanent category, and “Mike is at work” might be put into a transient category. The number of categories may vary. Context data will be described in further detail below in connection with FIG. 4.

As shown in FIG. 1, the network 106 may store many entity objects 110(1) . . . 110(m). Similarly, the network 106 may also store many identity objects 112(1) . . . 112(n). In addition, contexts 114 may be defined on a per object basis which means that each entity object 110 and each identity object 112 may have one or more contexts 114 associated with it.

Connecting to the network 106 may be a person 102 (also referred to herein as a user). The person 102 may connect to the network utilizing one of various network-enabled devices 104a . . . 104i. The network-enabled devices may include various types of hardware devices such as computers, handheld devices, televisions, mobile phones, GPS devices, Bluetooth enabled devices, RFID tags/devices, UPC tags/devices, or some other network-enabled devices somehow associated with a user 102. The various devices 104 may connect directly to the network 106 via a wireless or wired connection. Alternatively, the devices 104 may connect to other networks which are connected to the network 106. The user 102 may send and receive data from the network 106 using the devices 104 in a manner described in more detail below.

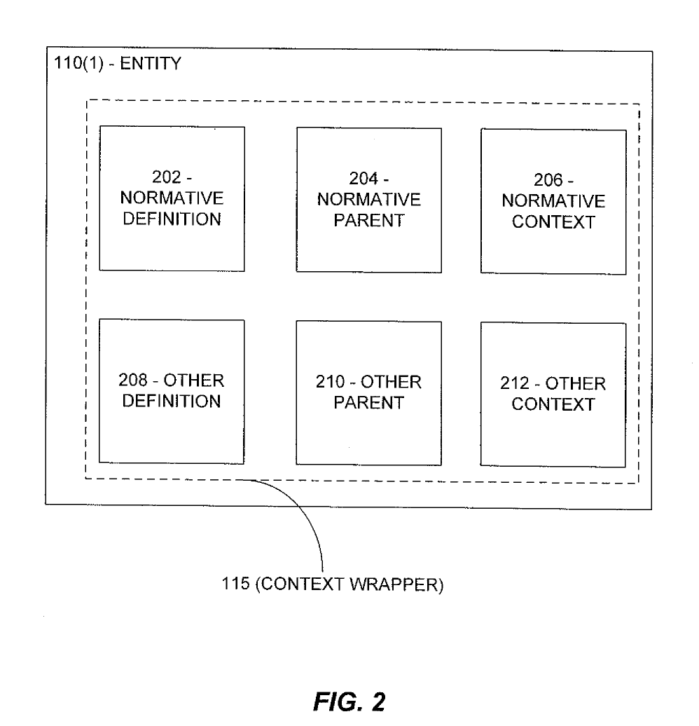

Referring now to FIG. 2, a more detailed view of an entity object 110(1) is provided. As noted above, an entity object 110(1) may have one or more associated contexts 114. To illustrate this association, the entity object 110(1) is shown with a context wrapper 115. Within each context wrapper 115, the entity object includes data which describes the entity within the specified context. An entity, such as entity 110(1), for example, may include normative definition data 202 which defines the concept being abstracted by the entity within the context 114 specified by the context wrapper 115. The normative definition data 202 includes data which defines the entity that is represented by the entity object 110(1). Each entity 110 may also include a normative parent data 204. The normative parent data 204 is data which represents a parent object of the entity object 110(1) within the context 114 defined by the context wrapper 115. The parent object may be an entity object 110 or an identity object 112. Within each context wrapper 115 associated with the entity object 110(1) may also be the normative context 206. The normative context 206 is the description of the context 114 that is specified by the context wrapper 115. In addition to the normative data provided within each context wrapper 115, each entity object 110(1) may further include an alternate definition 208, an alternate parent 210 and an alternate context 212. Providing alternate data such as the alternate definition 208, the alternate parent 210, and the alternate context 212 allows the user to be viewed simultaneously with different names, handles, or other identifiers in different systems that are being used, while maintaining a normalized key, protocol or service within the network 106 that enables the user to participate in transactions within the network, while utilizing the best features of each local network. By way of example and not of limitation, an entity object 110(1) may have a normative definition 204 which includes a specific name “Michael Smith” when using a credit card, in a credit card context. However, the network 106 may select an alternate definition 208, such as “Mike Smith” that is used many other places. In another context, the entity object may have still another alternate definition 208, such as “eek”, which corresponds to Mike's handle when using an online video game.

Referring now to FIG. 3, a more detailed view of identity object 112(1) is provided. As with the entity object 110(1), an identity object may have one or more contexts 114 associated therewith. As shown in FIG. 3, one particular context 114 is shown within a context wrapper 115. However, an identity 112(1) may have many different contexts each of which are delineated by a context wrapper 115. The identity object 112(1) may include a normative identification value or pattern. The normative identification value 302 is typically a unique identifier which distinguishes the real world thing which is represented by the identity. The identity 112(1) may also include a normative identifier type 304. The normative identifier type is the data type for the normative identity value 302. A normative identifier type 304 enables the network 106 to create a series of identifiers so as to maintain different sets of context for each object. For example, normative identifier types may include “long encrypted”, “16 character”, “picture”, “watermark”, “sensor”, or “logon”. Having different normative identifier types allows the network to provide proof of identity in various forms such that it is not constrained to one representation. This capability is particularly useful in situations where more and more devices are interconnected using various pervasive, near-field, sensor systems because it allows users to users to define contact with the devices around them by specifying rules of engagement between the various devices.

Normative identifier types 304 may also be combined for specific contexts in which the user exists. For example a normative identifier type 304 can be defined for a context in which the user is shopping with their mobile phone. Ordinarily, there may be an identifier associated with the user “MikeSmithMobileShop.” Which could be ID+ID+ID+ID (an id for each concept). This could be further extended to MikeSmithMobileBuy, which may look like IDLongVersion+IDLongVersion+ID+Logon. Accordingly, the identifier of the object can join with other identifiers and contexts to become more specific. Once the combination of normative identifiers has been created and processed, it can be made reusable by the system, or further obfuscated in encryption or some other security layer.

Each identity 112(1) may further include a secondary identifier 306 and a secondary identifier type 308 which may be alternative way of uniquely identifying the real world object represented by the identity object 112(1).

Depending on the type of object represented, the identity may include various other data fields which store relevant data about the identity object. As was briefly noted above, an identity object within the network 106 is a data abstraction of an object verified to exist in the real world. As such, each identity object 112 will store data related to how and when its existence has been verified. For example, identity objects 112 may include time data 310 which indicates the most recent date at which the existence of the object has been verified. The identity object 112(1) may further include one or more verification sources 312 which represent the entities 110 or identities 112 which have been used to verify this objects real world existence. Verification sources 312 may include logon records, session logs, cookies, sensors, magnetic strips, network identity services, operating system identity services, applications, cameras, retinal scanners, passwords, algorithms, directories, lists, databases, or frameworks. The verification source 312 can be different on different networks, applications, and contexts depending on the actions that are being performed. The identity objects may further include verification types 314 which provide information about the nature of the verification source 312. The verification types provide additional ways to abstract the verification sources 312. This enables the network 106 to define dependent actions based on verification types 314, rather than only being able to access the sources themselves. For example, an identity object 112 may be designated as having a verification type of “requiring network services.” Depending on the context in which the identity object 112 is operating, the network 106 can quickly determine if it can perform that type of verification. Other types of verification may be based on security level, application functionality, standards, technologies, or other standard questions such as who, what, where, why, how it runs.

Because identity objects represent a real world objects that have been verified to exist (in a given context), and thus may be granted certain privileges in the network based on these verifications, the verification data 312 and 314 provides a basis for which other objects in the network 106 may grant privileges.

Referring now to FIG. 4, a more detailed view of context data 114 from FIG. 1 is provided. As noted previously, context 114 refers to a set of facts or circumstances that within which a data object 109 is perceived. Contexts 114 stored in the network 106 may include general contexts and object-specified contexts. FIG. 4 illustrates various examples of general contexts 114. These general contexts may include a work context 114(a) which means that the data object 109 operating within the context is in a work environment. The general contexts may also include a shopping context 114(b) which means that the data object 109 operating within the context is in a shopping environment. Various other general contexts may include a home context 114(c), a school context 114(d), a travel context 114(e), a vacation context 114(f), a sleep context 114(g), and a sports context 114(h). Contexts 114 may also be defined that are specific to a particular data object. For example, a data object 109 may represent a specific person. That person may wish to define a context specific to a real world environment situation such as being in a specific location (such as a foreign country, for example), or being with a specific person (such as a business associate) or group of persons (such as their family). Each of these specified contexts 114 for a data object allows access to the data object to be managed according to its current context(s) and the rules defined and associated therewith. Contexts maybe grouped, nested, layered, and connected to other contexts 114. For example, if “Mike” has “Private” context (which generally makes “Mike” unavailable to others through the network 106), and “Megan” (married to Mike) has an emergency context, the emergency context of “Megan” may override the general rules of the “Private” context of “Mike.” Thus, if “Megan” is set to emergency, the network 106 may send a message to “Megan” indicating the location and status of “Mike”, e.g. Mike is in car, with phone. Extending further, if “Megan” has an emergency, and “Mike” isn't reachable, but Ben is Mike's best friend, and was last seen with Mike, the private context of “Mike” may enable the network 106 to send a message to “Mike” on behalf of “Megan” (without providing additional information without the consent of “Mike”).

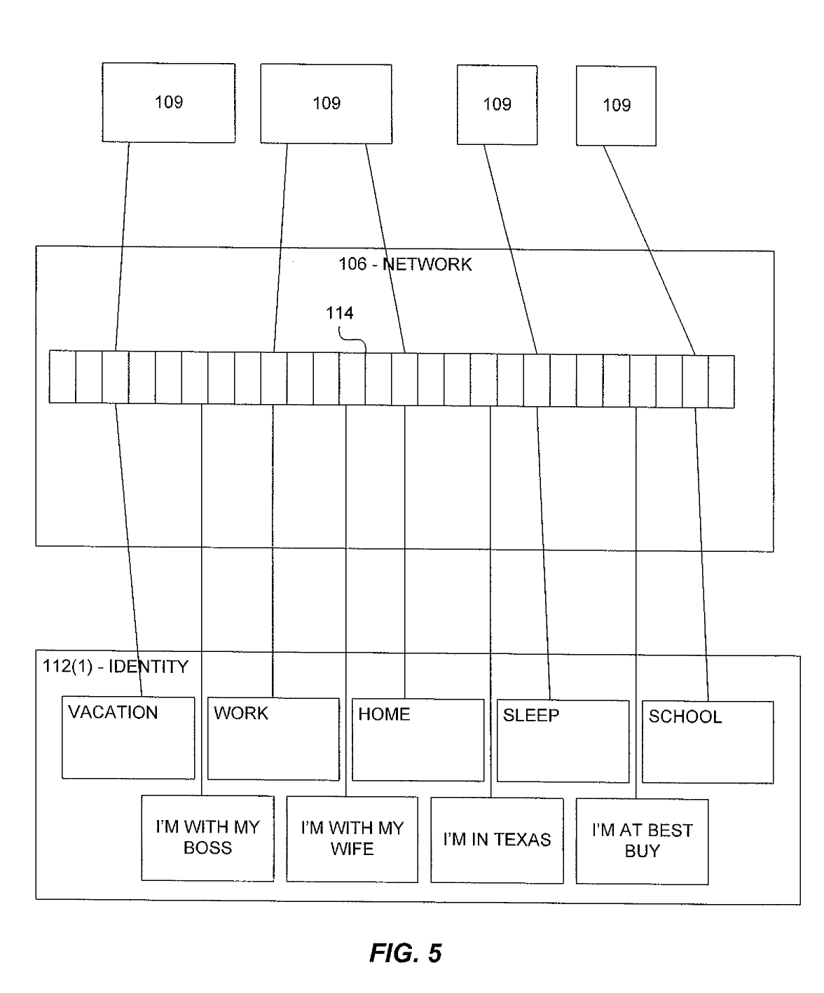

To further illustrate, an example of how a specific identity object 112(1) may communicate with other data objects 109 within the network 106 is provided in FIG. 5. In this particular example, the identity object 112(1) represents a person who connects to the network 106 in various ways depending on the situation they are in. The identity object 112(1) includes several situations which become defined contexts 114 for the identity object 112(1). Some of the situations align with general contexts 114 which are not specific to the identity object 112. These include “VACATION”, “WORK”, “HOME”, “SLEEP”, and “SCHOOL”. There may be many other general contexts available to the object. Other contexts 114 are defined that are specific to the identity object 112. These specific contexts 114 may be defined by the person associated with this identity object, or they may be defined by the network 106 based on the object's previous interactions with the network 106. FIG. 5 includes object-specific contexts 114 such as “I'M WITH MY BOSS” and “I'M AT BEST BUY”. Depending on the context, the identity object 112(1) is made available to other data objects 109 in the network. Thus, while in the “WORK” context, the identity object 112(1) may be available to one group of data objects in the network, while in the “SLEEP” context, the identity object 112(1) may be available to other data objects.

In some embodiments, the user is able to define how its identity object will communicate with the network 106 based depending on the context. Thus, for the contexts shown in FIG. 5, the user may specify who has access to communicate with them, and they may further define the terms of those communications. For example, the user associated with the identity object 112(1) may define the “I'M WITH MY BOSS” context such that only emergency communications from certain other specified data objects (such as an identity object 112(2) representative of a family member of the user) can reach him when that context has been set within the network 106.

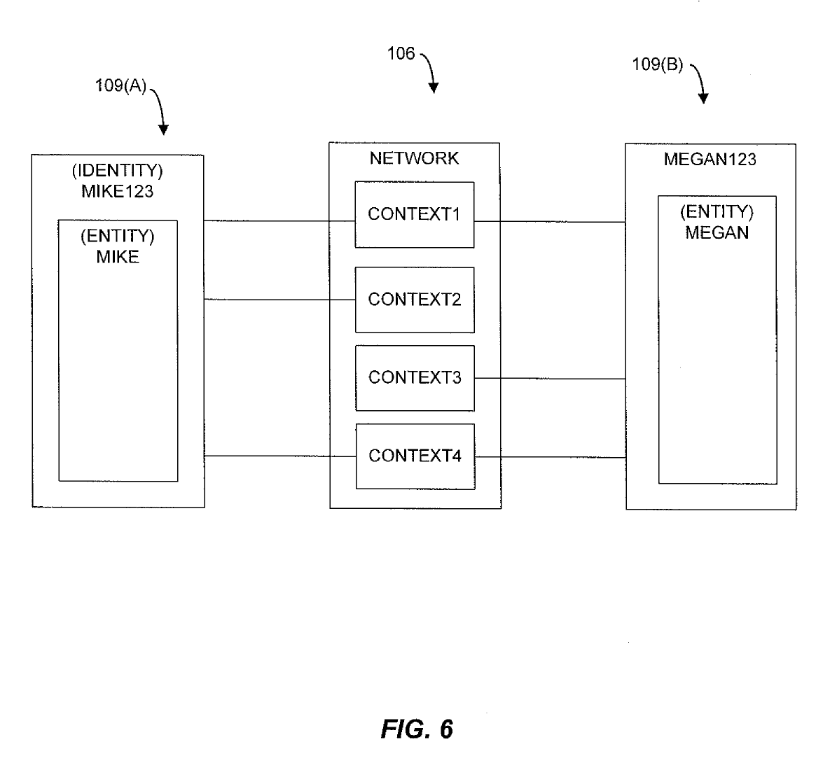

The contexts 114 defined for objects may also govern how two objects communicate through the network 106. FIG. 6 provides an illustration of how communication between two data objects 109(a) and 109(b) in the network 106 varies depending on the current context of the data objects. Data object 109(a) is an identity object with a normative identifier 302 of “MIKE123”. This identity object is associated with the entity object “MIKE” which represents the concept of the person “Mike” in the real world. Similarly, the data object 109(b) comprises an identity object with a normative identifier 302 of“MEGAN123”. This identity object is associated with the entity object “MEGAN” which represents the concept of the person “Megan” in the real world.

Within the network 106 are various contexts 114. Relationships may be provided using various contexts. As used herein, a relationship describes if two objects communicate, and if so, how two objects communicate. The relationship may further define the information that can be communicated. The relationship may further define how or in what form an object receives the information. In certain ones of the contexts (CONTEXT1 and CONTEXT4, for example), the “MIKE” data object 109(a) communicates with the “MEGAN” data object 109(a) via the network 106. In other contexts, however, the two data objects do not communicate. There can be various reasons why the objects do not communicate in certain contexts. For example, the “MIKE” data object 109(a) may have set its context to “PRIVATE” so that he is not visible to any other network objects. In such a situation (as is shown with CONTEXT2 in the drawing), the “MIKE” data object 109(a) will still connect with the network 106, but the “MEGAN” object is not able to communicate with “MIKE” while in that context. Similarly, there may be contexts (such as CONTEXT3, for example) where “MIKE” 109(a) cannot communicate with “MEGAN” 109(b) through the network based on a context set by Megan. Thus, the use of context 114 allows network objects 109 to control how they interact with the network 106, and further control how the network is able to interact with them.

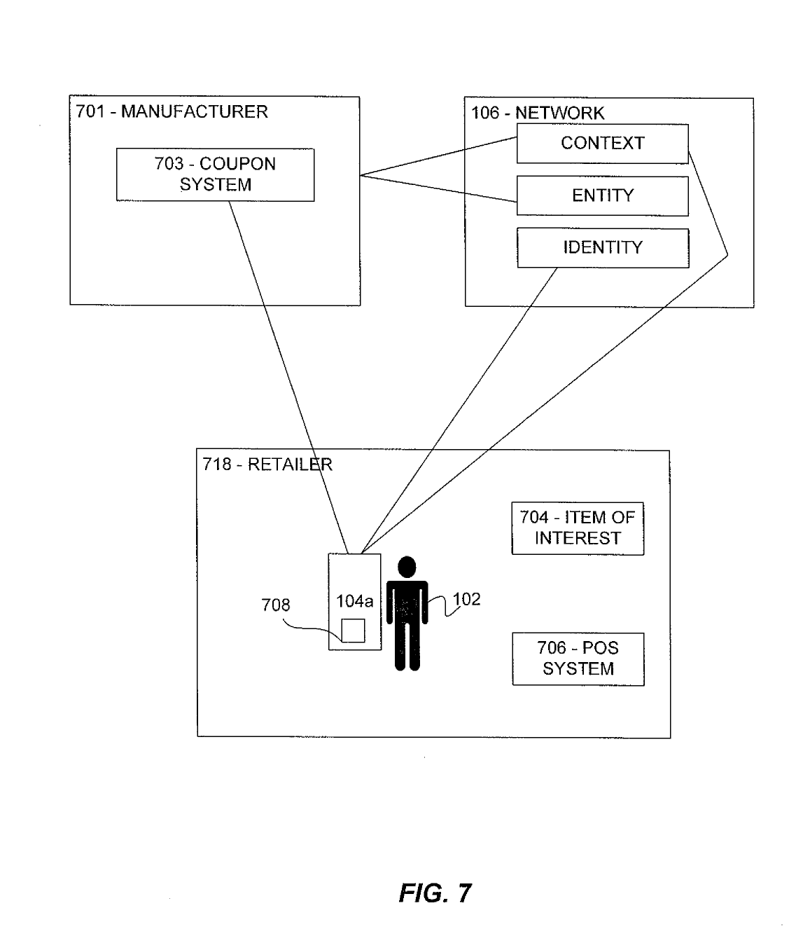

In one particular embodiment, the network 106 allows a context 114 to be defined for a person as they shop for products. Based on this context 114 various entities and identities within the supply chain may be allowed to communicate with the person based on rules defined by that person for the specific context. FIG. 7 is a block diagram illustrating a use case in which a user may receive a mobile coupon through the network 106 based on a specified context 114. As shown in the diagram a person 102 is located at a retailer premises 718. The person 102 has a network enabled device 104(a) such as a mobile phone which connects to the network 106. The mobile phone device 104(a) has an associated identity object 112 in the network 106. When the person 102 enters the retailer 718, he may set the current context within the network 106 to “SHOPPING”. Alternatively, the network 106 may be configured to automatically detect his presence in that location and set the context 114 for the device 104a automatically.

Within the retailer premises 718 may be one or more items of interest 704 which the person 102 wishes to possibly purchase. These items may be specified by the person 102 within the context 114, or they may be determined by the network 106 based on previous business transactions may be the person 102 within the network 106. Also located at the retailer premises is a point of sale (POS) system 706. The POS system 706 may be connected to the network 106, or it may be connected to some other computing device with connects directly to the network 106.

Also connected to the network 106 may be a manufacturer 701. The manufacturer 701 may be a network object 109 such as an entity 110 or an identity 112. The manufacturer 701 may include a coupon system 703 which is configured to send coupons to mobile devices such as 104(a) for the purchase of items provided by the manufacturer through the retailer 718. The coupon system 703 may be configured to provide general coupons for all of the manufacturer products, or it may be configured to provide coupons for specific products sold at the retailer 718.

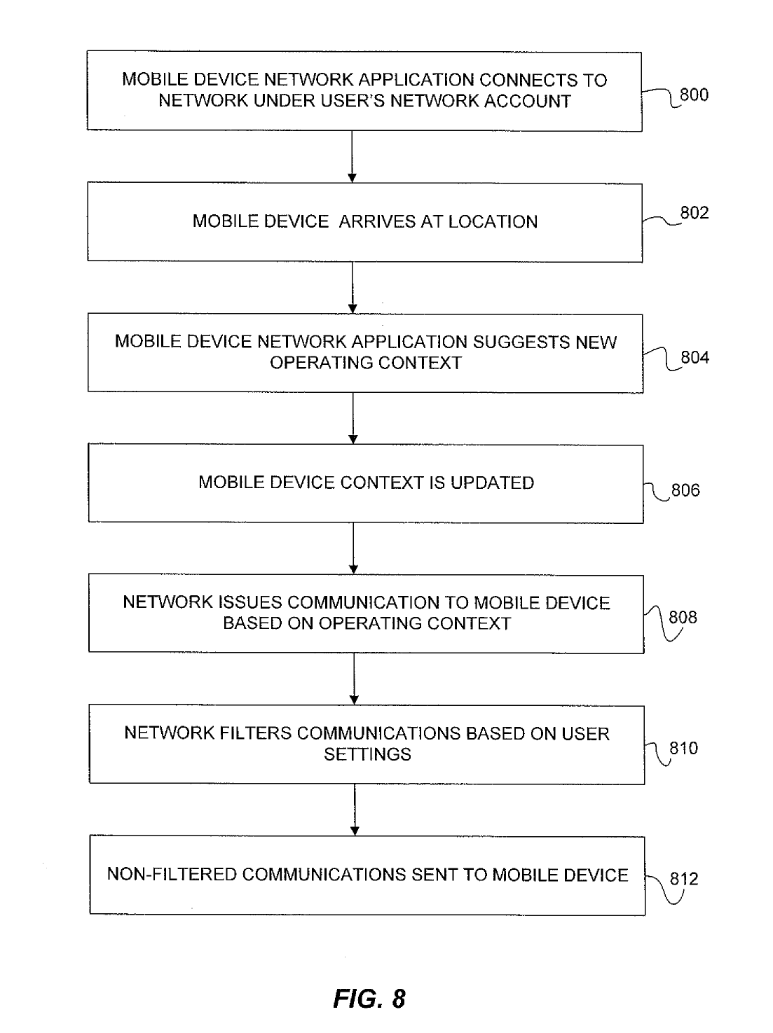

As noted above, context 114 for a network object 109 such as the mobile phone 104(a) may be set based on a user's location. FIG. 8 is a flowchart of a process by which a mobile device of a user (such as mobile device 104(a) from FIG. 7) can attach to the network 106 and communicate with other objects on the network based on the context 114. The process begins at block 800 where the mobile device connects to the network using a network account associated with the person 102 using the mobile device 104(a). Upon connecting to the network 106, the mobile device 104(a) is recognized as a data object 109 (either an entity 110 or an identity 112) in the network 106 and an initial context is set for the data object 109. Next, the mobile device 104(a) arrives at a location such as retailer 718, for example at block 802. Upon arriving at the new location, the network 106 suggests a new operating context for the mobile device at block 804. As discussed above, this process may be automatic, or in some embodiments, the user 102 may specify the context 114 manually. Next at block 806, the context 114 for the mobile device 104(a) is update within the network 106. Once the context 114 has been updated, the network 106 then routes messages to the mobile device 104(a) at block 808. At block 810, the network filters the messages based on the settings associated with the context 114. To further illustrate this filtering, if “Megan” calls “Mike” with an emergency, and she is in group “Family” it may overrides a standard privacy setting for “Mike.” “Mike” has ultimate control, but can have selective filtering rules which extend to email, voice, voice over IP (VOIP), sms, video, rss, print and other communication methods that “Megan” (or some other family member identity object) may use to contact “Mike”. Once the messages are filtered, the non-filtered messages are sent to the mobile device at block 812.

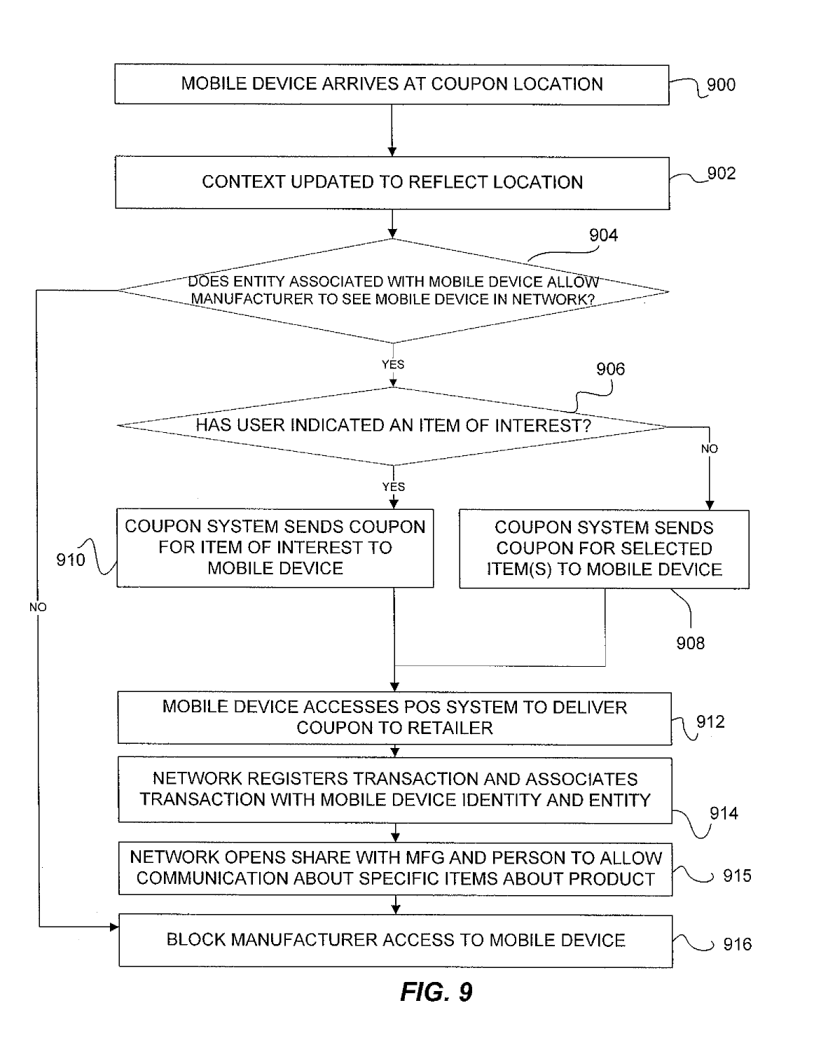

As noted above in connection with FIG. 7, certain embodiments provide manufactures with the ability to send mobile coupons to mobile devices 104(a) based on their current context 114. FIG. 9 is a flowchart describing an example of such as process. The process begins at block 900 where a mobile device 104(a) associated with a person 102 arrives at a coupon location such as the retailer 718. Next, the context of the mobile device 104(a) is updated to reflect the location. This update may be accomplished using the process described above in connection with FIG. 8. Next, the process moves to decision block 904 where the network determines whether the person 102 associated with the mobile device 104(a) has set the context to allow the manufacturer 701 to see the mobile device within the network 106. If the person 102 has not allowed the manufacturer 701 to be made aware of his presence at the retailing location, the process skips to block 916 where the network 106 block manufacturer access to the mobile device.

If at decision step 904, the person associated with the mobile device identity object does in fact allow the manufacturer 701 to see the mobile device in the current context 114, the process moves to another decision block 906. At decision block 906 the system checks to see if the user 102 has indicated an item of interest. For example, this indication may be from an input into the device. Alternatively, the device may detect the presence of the item of interest via RFID or some other signal emitted by a device. If the user indicates an item of interest, the process moves to block 910 where the manufacturer receives notification of the item of interest and in response the coupon system 703 of the manufacturer 701 sends a coupon to the mobile device 104(a). If the user does not indicate an item of interest at decision block 906, the process instead moves to block 908 where the coupon system 703 sends coupons for selected item(s) which are available at the retailer location 718 to the mobile device coupon system.

From either block 908 or 910, the process moves then to block 912 where the mobile device 104(a) accesses the point of sale system 706 to deliver the coupon to the retailer. Typically this will occur when the user 102 has made a purchasing decision and arrives at the point of sale. Once the coupon has been delivered to the POS system 706, at block 914 the network registers the transaction and associates the transaction the mobile device identity and the other parties involved in the transaction. After the transaction has been registered in the network, the process then moves to block 915 where the network provides an interface to allow the customer to define how they would like future communication from the manufacturer regarding the purchased product.

As noted above, in block 914, the network 106 registers the transaction and associates the transaction with the parties involved. Storing information about the transaction allows details about the transaction to be shared throughout the supply chain. In some embodiments, the system allows the purchaser 102 and manufacturer 701 to develop a framework for future network communications regarding the purchase. For example, the user may specify a set of contexts 114 in which it would be appropriate for the manufacturer to communicate with the user 102 via the network 106.

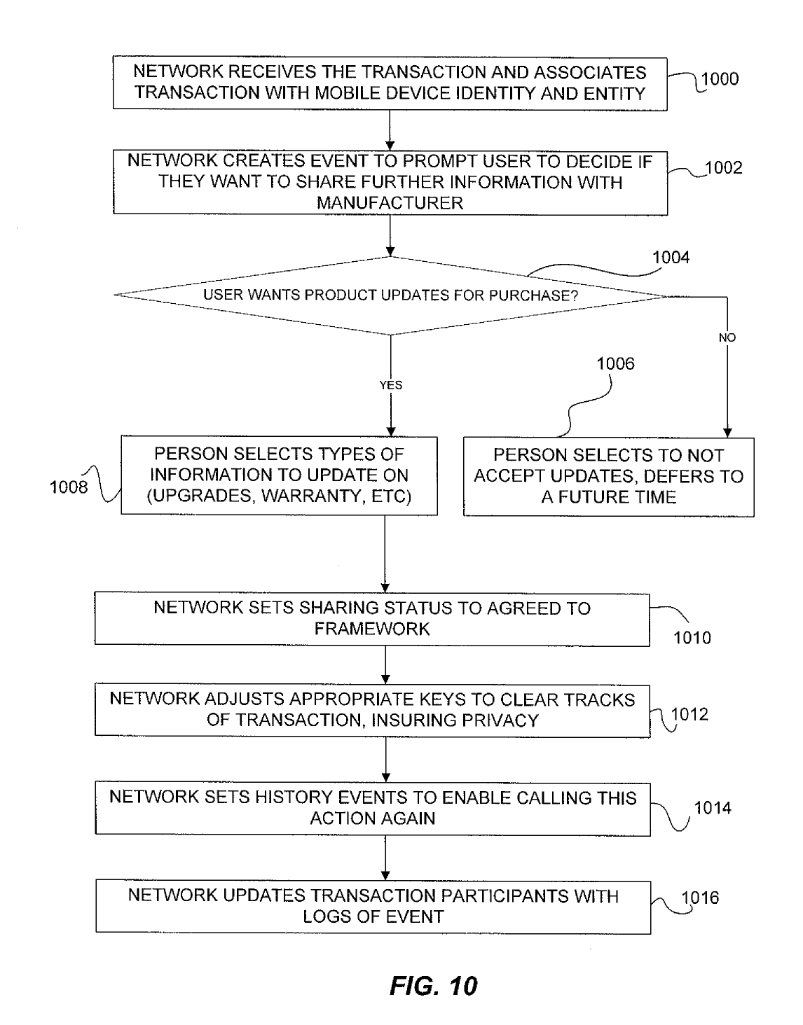

Referring now to FIG. 10, a more detailed view of how the network may handle the transaction from FIG. 9 is provided. The process begins at block 1000 where the network 106 receives the transaction details and associates the participating data objects 109 with a transaction object that is created in the network 106 to store information about the transaction. Next, at block 1002, the network 106 creates an event to prompt the user 102 of the mobile device 104(a) to decide if they want to share additional information with the manufacturer 701 of the purchased item.

Next, the process moves to decision block 1004 where the user 102 decides whether they want to receive products updates from the manufacturer 701 via the network 106 for the purchase. If the user 102 chooses not to accept further communication, then the process moves to block 1008 where the user 102 can defer the decision until a later time or they may decide not to receive updates at all. If at decision block 1004 the user 102 chooses to continue receiving product updates, the process moves to block 1008 where the user 102 selects the types of information for which updates are desired. These types of information may include product warranty information, product upgrade information, product recall information, or some other information related to a purchased product.

Once the user 102 has made their selection, the process moves to block 1010 where the network sets the sharing status between the user and the manufacturer based on the agreed to framework. The sharing status may be based on a set of temporary keys which are defined in the network 106 based on the context 114 of the transaction as it relates to each of the participating entities 110. The temporary keys are used to log the transaction details for a limited period of time. Once the sharing status is set, the process then moves to block 1012. There, the network 106 adjusts appropriate keys in the network so that the certain portions of the transaction become shielded from the participants.

Once the keys have been set, the process then moves to block 1014 where the network 106 stores the adjusted keys and the data associated with the adjusted keys. This process allows the network 106 to have future access to the transaction records so that they are accessible, if necessary, in the future. The process then continues to block 1016 where the network updates the data objects 109 representing each transaction participant with data related to the purchase event.

### EXAMPLE

### User Changes Addresses

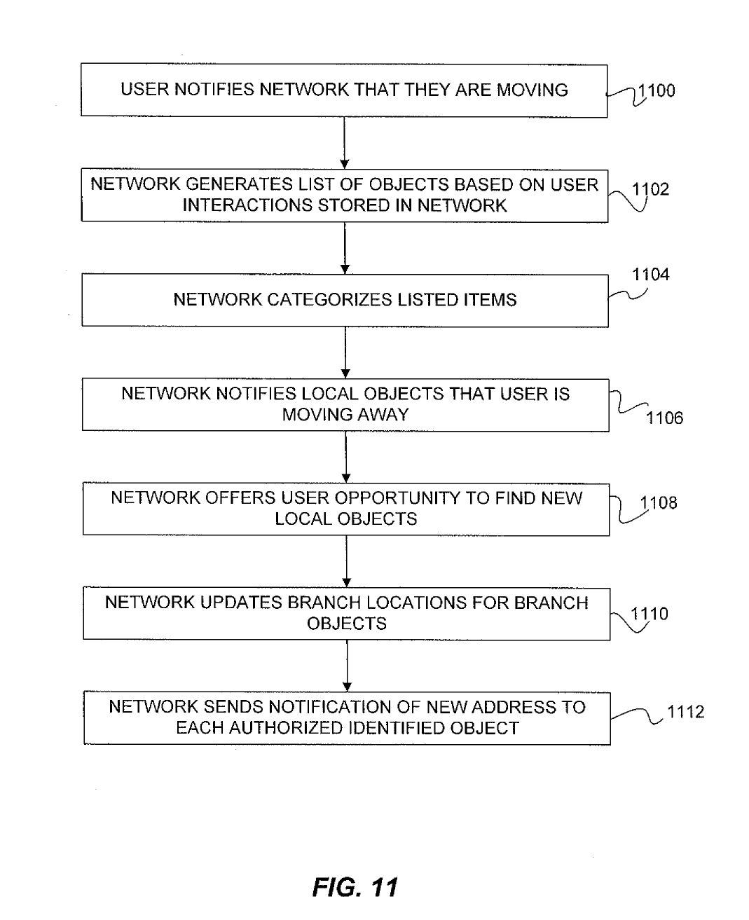

As noted previously, existing network technologies do not handle situations in which a person moves their home. In one embodiment, the network system described herein provides these services with minimal disruption and inconvenience to the user and the organizational entities associated with the user. Referring now to FIG. 11, a flowchart is provided which describes a process by which the network 106 helps a user (as represented by an identity object 112 in the network) perfect a change of address with other objects in the network 106, and similarly update those objects in view of the change of address.

The process begins at block 1100 where the user connected to the network 106 as an verified identity object 112 sends a message to the network 106 indicating that they want to move their home address to a new location. Next, at block 1102, the network 106 generates a checklist of other objects (both entities 110 and identities 112) which share address data with the identity object 112 of the user. This list may include objects representing businesses such as a bakery, a hair salon, a bank, a pizzeria, the local DMV branch, and a retail store such as “Best Buy”. In addition, the system may retrieve information from other companies that have done business with the user, and shared their address information, such as manufacturers “Sony” or “Microsoft” by way of previous transactions recorded in the network 106.

Next, the process moves to block 1104 wherein the network 106 categorizes each of the objects in the generated list according to the context of their interactions with the user object 112. For example, the bakery and hair salon may be categorized as “local” object. As a result, if the user moves far away, these objects may no longer be relevant because the user does not live near them. Other listed objects may be categorized as “branch” objects. Although the user's interaction with these objects is local (e.g., within a geographic proximity to their current address), the nature of the business represented by the “branch” object means that their may be a branch for that business in the new address location. Other objects may be categorized as “global” objects. These objects may represent those organizations which are national or global in nature, such that the user's interactions with them are not dependent on their home location. It should be noted that for each of the objects identified by the network, the user object may store an address for a business, and the business may store an address for the user. For the local and branch objects, both stored addresses may need to be updated, while for the global objects, only the address associated with the user may change.

Once the objects have been categorized, the process moves to block 1106 where the local objects are notified that the user is moving. These notifications may take the form of an automated phone call made by the network 106 or some other electronic communication sent to the object representing each of the local businesses. Next, at block 1108, the network may offer the user the opportunity to select new local objects to replace the old local objects. For example, the network may suggest a new bakery to add to the user's profile which is located near their new address. Next, at block 1110, the network 106 determines if there are branch locations for the branch objects near the user's new address. If branch locations are found in the network 106, these objects are updated accordingly to reflect their new local addresses in relation to the new address for the user.

The process then moves to block 1112 where the network 106 notifies each of the identified objects of the change in the user's address. This, of course depends on whether the user shares their home address data with any or all of the listed objects. These updates may be propagated through the use of secure messaging (in the case of a bank branch, for example), an automated phone call (in the case of a pizzeria branch, for example), an e-mail, via a defined API within the network 106, or some other communication.

It will be understood by those of skill in the art that numerous and various modifications can be made without departing from the spirit of the present invention. Therefore, it should be clearly understood that the forms of the invention are illustrative only and are not intended to limit the scope of the invention.

What is claimed is:

1. A system for creating and maintaining relationships between data elements in a network comprising:
a server configured to store a unique identity object for a first data element and distribute it to other servers;
a first module configured to store a plurality of contexts associated with the first data element;
a second module configured to apply one of the stored contexts to the first data element; and
a third module configured to provide a relationship between the first data element and other data elements using the applied context.

2. The system of claim 1, wherein the first data element is a person on the network.

3. The system of claim 1, wherein the other data elements comprise entities in the network.

4. The system of claim 1, wherein the other data elements comprise identities in the network.

5. The system of claim 1, wherein the first server is further configured to store a unique identity object for at least one of the other data elements.

6. The system of claim 1, wherein the unique identity object for the first element is created based on a verification of a real world existence of the first data element.

7. The system of claim 6, wherein the verification is provided by a verification source.

8. The system of claim 7, wherein the verification source comprises an identification of relationships between the first data element and other data elements having unique identity objects associated therewith.

9. The system of claim 3, wherein the entities in the network represent ideas and/or concepts that exist.

10. A system for creating and maintaining relationships between persons and other entities comprising:
a server configured to store a unique identity object for each person;
a first module configured to store a plurality of contexts associated with each person;
a second module configured to apply one of said contexts to a first person; and
a third module configured to provide a relationship between said first person and the other entities using the applied context.

11. The system of claim 10, wherein the other entities comprise additional people.

12. The system of claim 10, wherein the other entities comprise stores, restaurants, or manufacturers.

13. The system of claim 10, wherein the unique identity object is a software object.

14. The system of claim 10, wherein the first module comprises a data storage system configured to store the plurality of contexts and the unique identity objects.

15. The system of claim 10, wherein the contexts comprise “at work”, “at home”, “in school”, “do not disturb”, “shopping”, or “busy” contexts.

16. A computer-implemented method for creating and maintaining relationships between users and other entities in an electronic system, comprising:
determining a unique identity for a user of the system;
selecting a context for the user, wherein the context determines how other entities communicate with the user;
identifying an entity that desires to communicate with the user; and
providing a communication link between the user and the entity, wherein the entity communicates context-sensitive information to the user.

17. The computer-implemented method of claim 16, wherein contexts may be defined by the user.

18. The computer-implemented method of claim 16, wherein determining a unique identity comprises receiving personal information from the person through a website.

19. The computer-implemented method of claim 16, wherein selecting the context for the user comprises receiving a request for the context from the person.

20. The computer-implemented method of claim 16, wherein the communication link comprises an identification of a preferred email address.

21. The computer-implemented method of claim 16, wherein the communication link comprises an identification of a preferred telephone number.

22. The computer-implemented method of claim 16, wherein the communication link comprises a voice-over internet protocol (VOIP) telephone link.

23. A computer-implemented method of transmitting data between a first entity and other entities based on predefined relationships between the entities, the entities being connected to a digital network, the method comprising:
receiving a message indicative of the first entity's presence in a location;
selecting a context for the first entity based at least in part on the location;
determining the first entity's relationships with other entities which are relevant to the entity in the selected context; and
sending context-sensitive data from at least one of the other entities to the entity based on the entity's relationships.

24. The computer-implemented method of claim 23, wherein the first entity comprises a mobile device.

25. The computer-implemented method of claim 24, wherein the current context for the mobile device comprises “at work”, “at home”, or “shopping”.
